(19) United States
(12) Patent Application Publication
(10) Pub. No.: US 2014/0189087 A1
(43) Pub. Date: Jul. 3, 2014

(54) REMOTE REGISTRATION OF SYSTEMS

(71) Applicant: SAP AG, Walldorf (DE)

(72) Inventor: Yunhua CHEN, Shanghai (CN)

(73) Assignee: SAP AG, Walldorf (DE)

(21) Appl. No.: 13/735,990

(22) Filed: Jan. 7, 2013

(30) Foreign Application Priority Data
Dec. 31, 2012 (CN) 201210592192.0

(51) Int. Cl. H04L 12/24

(52) U.S. Cl. CPC H04L 41/00
USPC 709/223

(57) ABSTRACT

Described herein is a technology for facilitating remote registration for customer service. In some implementations, a customer relationship management (CRM) system of a service provider is provided. A remote registration application (APP) is provided at a remote client device for remote registration for service with the CRM system. The APP is configured to communicate with the CRM system. The remote registration APP is invoked by a user using the remote client device. Log in information is provided to the APP, wherein the APP communicates with the CRM system to register the user for service.

### TECHNICAL FIELD

The present disclosure relates generally to customer relationship management (CRM) systems. More particularly, the present disclosure relates to remote registration service using a remote device, including a mobile device.

### BACKGROUND

Customer relationship management (CRM) systems are widely implemented for managing companies' interactions with customers, clients and prospective clients and sales transactions, as well as other types of relationships or activities. For example, a CRM system organizes, automates and synchronizes business processes related to sales activities, including those for marketing, customer service and technical support. A CRM system models a company's businesses related to sales activities. For example, a CRM system may reflect a company's business strategy, including customer-interface departments as well as other departments.

As discussed, one aspect of the CRM system is related to customer service. Under current customer service models, customers are required to be physically present at customer service centers and register for service. Customers are provided with service based on the queue concept, such as first come first serve. In the event that there are large number of customers ahead in the queue, service to the newly registered customer may take a significant time. A long customer queue creates problem, such as crowded waiting area, emotional tension due to long waiting time, among other things.

Thus, a need exists for systems, methods, and apparatuses to address the shortfalls of current CRM systems.

### SUMMARY

A computer-implemented method for facilitating remote registration for customer service is described herein. The method includes providing a customer relationship management (CRM) system of a medical service provider. The method also includes providing a remote registration application (APP) at a remote client device for remote registration for service with the CRM system. The APP is configured to communicate with the CRM system. The method also includes invoking the remote registration APP by a user using the remote client device and providing log in information to the APP. The APP communicates with the CRM system to register the user for service. Upon successful registration, the APP provides the user registration information. The registration information includes a registration number, a number of other customers ahead of the user, and an estimated wait time.

In one embodiment, a computer-implemented method for remote registration for customer service is described herein. The method includes providing a customer relationship management (CRM) system of a service provider. The method also includes providing a remote registration application (APP) at a remote client device for remote registration for service with the CRM system. The APP is configured to communicate with the CRM system. The method also includes invoking the remote registration APP by a user using the remote client device and providing log in information to the APP. The APP communicates with the CRM system to register the user for service.

In one embodiment, a non-transitory computer-readable medium having stored thereon program code is disclosed. The program code is executable by a computer to provide a customer relationship management (CRM) system of a service provider. The program code is also executable by the computer to provide a remote registration application (APP) at a remote client device for remote registration for service with the CRM system. The APP is configured to communicate with the CRM system. The program code is also executable by the computer to invoke the remote registration APP by a user using the remote client device and provide log in information to the APP. The APP communicates with the CRM system to register the user for service.

In yet another embodiment, a system is disclosed. The system includes a non-transitory memory device for storing computer-readable program code. The system also includes a processor in communication with the memory device. The processor is being operative with the computer-readable program code to provide a customer relationship management (CRM) system of a service provider. The processor is also being operative with the computer-readable program code to provide a remote registration application (APP) at a remote client device for remote registration for service with the CRM system. The APP is configured to communicate with the CRM system. The processor is also being operative with the computer-readable program code to invoke the remote registration APP by a user using the remote client device and provide log in information to the APP. The APP communicates with the CRM system to register the user for service.

With these and other advantages and features that will become hereinafter apparent, further information may be obtained by reference to the following detailed description and appended claims, and to the figures attached hereto.

### BRIEF DESCRIPTION OF THE DRAWINGS

Some embodiments are illustrated in the accompanying figures. Like reference numerals in the figures designate like parts.

FIG. 1 is a block diagram illustrating an exemplary system environment;

FIG. 2 is a block diagram illustrating an software environment;

FIG. 3 shows an exemplary process of remote access to CRM system;

FIGS. 4A-F show screenshots of an exemplary remote application software; and

FIG. 5 shows an exemplary integration process.

### DETAILED DESCRIPTION

In the following description, for purposes of explanation, specific numbers, materials and configurations are set forth in order to provide a thorough understanding of the present frameworks and methods and in order to meet statutory written description, enablement, and best-mode requirements. However, it will be apparent to one skilled in the art that the present frameworks and methods may be practiced without the specific exemplary details. In other instances, well-known features are omitted or simplified to clarify the description of the exemplary implementations of present frameworks and methods, and to thereby better explain the present frameworks and methods. Furthermore, for ease of understanding, certain method steps are delineated as separate steps; however, these separately delineated steps should not be construed as necessarily order dependent or being separate in their performance.

Systems, methods, and apparatuses for facilitating the registration and access of data of a CRM system using a remote device are described herein. The remote device may be a mobile or non-mobile device. In one embodiment, the remote device is a mobile device. Other types of remote devices may also be useful. In one aspect of the present framework, customer information stored in a CRM system can be accessed by a remote device. The framework, for example, facilitates hospital registration and querying information using a remote device. The remote device may be a mobile or non-mobile device. In one embodiment, the framework, for example, facilitates hospital registration and querying information using a mobile device anywhere and anytime. Accessing other types of CRM systems may also be useful.

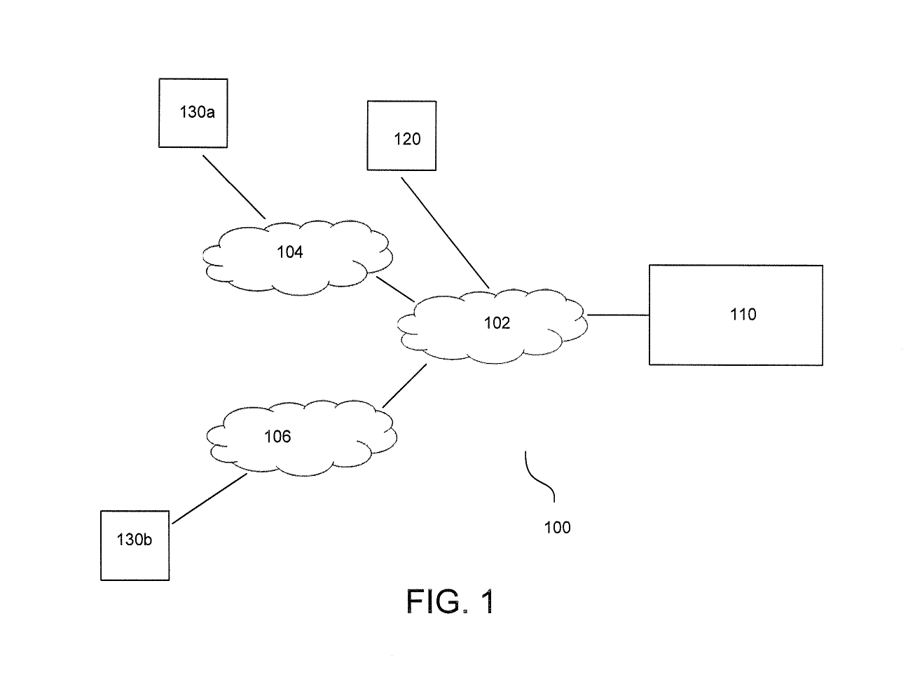

FIG. 1 shows a block diagram of an exemplary environment 100. The environment, for example, facilitates remote registration of a CRM system. The environment also facilitates remote access of information from a CRM system. The environment may have a client/server (C/S) architecture. For example, the environment may be a distributed C/S architecture. Other types of environments may also be useful. For example, the environment may be a cloud computing environment.

In one embodiment, the environment includes one or more servers 110 communicatively coupled via an internal communication network 102. The internal communication network, for example, may be a local area network (LAN) which interconnects different devices, such as the clients and server. Other types of networks may also be useful. The devices may be coupled via the network by wireless and/or wired connections.

The server, in one embodiment, may be a computer which includes a memory and a processor. The server is configured to transmit, receive, process and store information or data associated with the environment. Various types of computers may be employed. For example, the computer may be a mainframe, workstation, as well as other types of processing devices. The server may be adapted to execute any operating system. For example, the operating system of the server may be z/OS, Linux-Intel, Linux/390, UNIX, or Windows Server. Other types of operating systems may also be used. The server may also include or be communicatively coupled with a web server and/or a Simple Mail Transfer Protocol (SMTP) server.

Although the environment is illustrated with one server, it is understood that more than one server, such as a server pool, as well as computers other than servers, may be employed.

The memory of the server may include any non-transitory memory or database module. The memory may be volatile or non-volatile types of memories, such as magnetic media, optical media, random access memory (RAM), read-only memory (ROM), removable media, or any other suitable local or remote memory component.

Clients are communicatively coupled to the internal network to communicate with the server. Furthermore, the server may facilitate communication between clients.

An internal client 120 is coupled to the internal communication network. As shown, the internal client is directly coupled to the internal communication network. The internal client may be coupled by wired connection or by a wireless connection. The internal client, for example, may be a desktop or a laptop computer. Other types of computing devices may also be useful for the internal client. First and second external clients 130a-b are indirectly coupled to the internal communication network by first and second external communication networks 104 and 106. The external communication networks may be considered as wide area networks (WANs). The first external communication network, for example, may be the internet. In such case, the first external client may be any type of computing device, including a desktop computer, laptop computer, or a mobile communication device with processing capabilities, such as a smart phone or a tablet computer. As for the second external communication network, it may be a mobile communication network, such as a 3G or 4G network. In such case, the second external client may be any mobile communication device with processing capabilities, such as a smart phone or tablet computer. Other types of external clients or external communication networks may also be useful.

Software applications may be provided in the environment. The applications, for example, may include C/S applications. Generally, C/S applications include frontend and backend portions. The frontend portions are stored locally on the clients while the backend portions are located in the server. Various types of C/S applications may be provided in the environment.

A client may include a user interface for a user to interface with the environment for various purposes. For example, the interface may be used to access various applications in the environment. The user interface may also serve other purposes. In one embodiment, the user interface includes a graphical user interface (GUI). A GUI may provide an efficient and user-friendly manner of presenting information or communicating with the environment. For example, a GUI may include a task menu as well as one or more panes for displaying information. Other types of user interfaces, such as command line interface (CLI), may also be useful. The type of user interface may depend on the type of application running on the client. For example, the frontend portion may include a GUI to enable a user to interact with the backend portion to access data stored in the server.

It is understood that the environment may include other internal and external clients as well as other internal and external communication networks. Additionally, other types of devices may be included. Furthermore, “client” and “user” may be used interchangeably as appropriate without departing from the scope of this disclosure. For example, a client may be used by one or more users while a user may use one or more clients. As an illustration, a user may have a user account for an application, such as the email system. Any user may access the user's respective account from any client by performing an authentication or a login process, such as providing a user name and password.

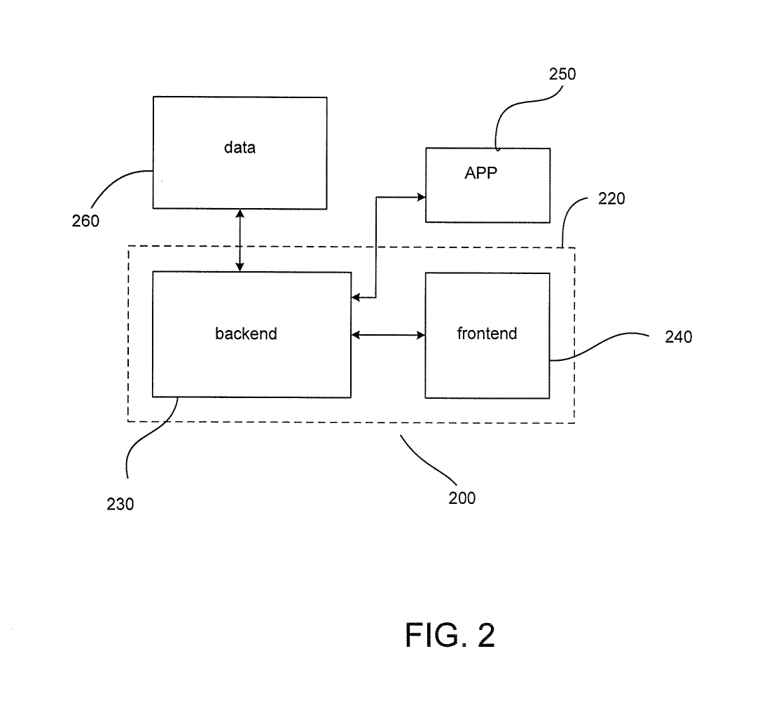

FIG. 2 shows a block diagram of an embodiment of a software environment 200. In one embodiment, the software environment includes a CRM system 220 of a service provider. The CRM system, for example, is a SAP CRM system from SAP AG. Other types of CRM systems may also be useful. The CRM system manages, for example, customer service procedures, including registration by a customer for service, time to service, type of service, and cost of service. The CRM system may also manage other procedures related to customer service provided by the service provider. The CRM system may be customized to accommodate the service provider.

In one embodiment, the CRM system has a C/S architecture. For example, the CRM system includes a backend subsystem 230 and a frontend subsystem 240. The backend subsystem is contained in the server while the frontend subsystem is contained in the client device. A copy of the frontend subsystem, for example, is provided for each client device. A user, such as a service representative or a customer, interacts with the CRM system through the frontend subsystem.

Data input into the CRM system is stored in a data source 260. The data source, for example, is a database. The data stored may be in the form of data files, spreadsheets or reports. Storing the data in other forms may also be useful. The data may be related to, for example, information related to customers, dates, times, accounts, service departments and services. For example, in the case of medical service, the information may include date/time, medical card account, clinic and service requested. Other information related to customer service may also be useful. The information, for example, may be stored in one or more tables. The structure of the tables may depend on, for example, the CRM system.

In one embodiment, a remote registration application 250 is provided. The remote registration application facilitates remote registration of the CRM system by a user. In one embodiment, the remote registration application may be an application software (APP). The remote registration APP is contained in the client device. In one embodiment, the client device is a mobile client device, enabling remote registration anywhere and anytime. Remote registration by non-mobile client devices may also be useful.

In one embodiment, the remote registration APP may be a universal remote registration APP. For example, the remote registration APP may be configured to access CRM systems of different service providers. The service providers may be similar types of service providers. For example, the service providers may be medical service providers, such as hospitals. Other types of service providers may also be useful. Multiple service providers may be provided through a look up table of service providers. The look up table may be provided by a service or over the internet. In other embodiments, the APP is dedicated to a specific service provider.

The CRM backend subsystem, in one embodiment, includes various functional modules for interfacing with the remote registration APP. For example, the functional modules enable the remote registration APP to remotely register a user and provide registration information to the user.

A user may use the remote registration APP to register for service with a service provider. For example, a customer having an account with a service provider may be assigned a unique customer number which the customer may use to remotely register with the CRM system of the service provider. In the event that a customer does not have an account, a separate process may be provided to sign up for a new account.

In the case of a universal remote registration APP, the user may select the desired service provider. In some cases, the APP may provide the user with recommended service providers. The recommendation, for example, may be based on the location of the user, which may be identified by GPS of the mobile device. For example, the APP may recommend service providers which are near to the user's location. Alternatively, in the case of a dedicated APP, no selection is required or suggestion is provided.

As part of the registration process, the customer is asked to provide the unique customer registration number associated with the selected service provider. Additional information requested may include the type of service requested. Upon successful registration, the CRM system may provide the customer with a queue number along with the number of customers waiting ahead and expected waiting time to be served. Other information provided by the CRM system may include, for example, cost of service and user's account information. In the case of a registration to a hospital, user's medical card account information may be provided.

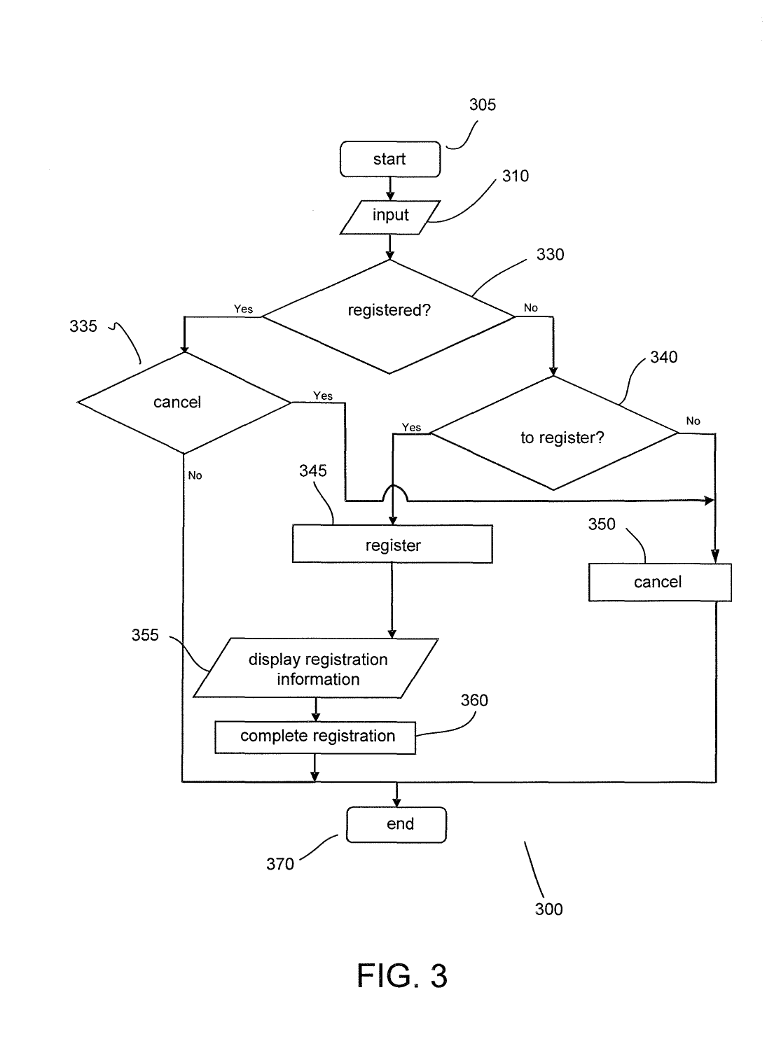

FIG. 3 shows an embodiment of a process 300 for a remote access or registration of a CRM system by a customer. The remote access process, for example, is provided as an APP. The remote access process, for example, enables a user to remotely register with a CRM system for service and/or to query for information from the CRM system.

In one embodiment, a user with a customer account initiates the remote access process at step 305. In some cases, the APP may provide the user with recommended service providers. For example, one or more service providers may be recommended based on the location of the user. A user selects a service provided from which service is desired. At step 310, the user enters information to log into the CRM system of the selected service provider. For example, the user enters a unique account name and password to log into the CRM system. The unique account name may be a sequence of numbers, alphabets or a combination thereof, such as alphanumeric characters. The log in process may also include the name of the service provider and type of service requested.

Based on the log in information, the process accesses the CRM system and authenticates the user. If the user is authenticated, the CRM system provides relevant information to the user. For example, the CRM system provides status information, such as number of customers currently in the customer queue for service and estimated waiting time to be served. Additional information may include registration status and registration number of the user, if already registered.

If the user is not registered, the process proceeds to step 340. Otherwise, the process proceeds to step 335 if the user is already registered with the CRM system. At step 330, if the registration status is unregistered, the user may decide to register with the CRM system for service. If the user desires to register with the CRM system, the process proceeds to step 340. At step 340, the user has the option to register with the CRM system. If the user decides not to register with the CRM system, the process proceeds to step 370 for process termination.

On the other hand, the process proceeds to step 345 to commence the registration of the user with the CRM system. The CRM system displays user registration information at step 355. User registration information includes, for example, registration or queue number, type of service, number of customers ahead and estimated waiting time to be served. Providing other types of user registration information may also be useful. After displaying the user registration information, the user may confirm registration at step 360, completing the registration process. After completing registration, the process terminates at step 370.

If the user is registered at step 330, the process proceeds to step 335, where the user may cancel the existing registration at step 335. If the user selects to cancel registration, the process proceeds to step 350 for cancellation. After cancellation, the process terminates at step 370. If the user selects to keep the registration, the process proceeds to step 370 for termination.

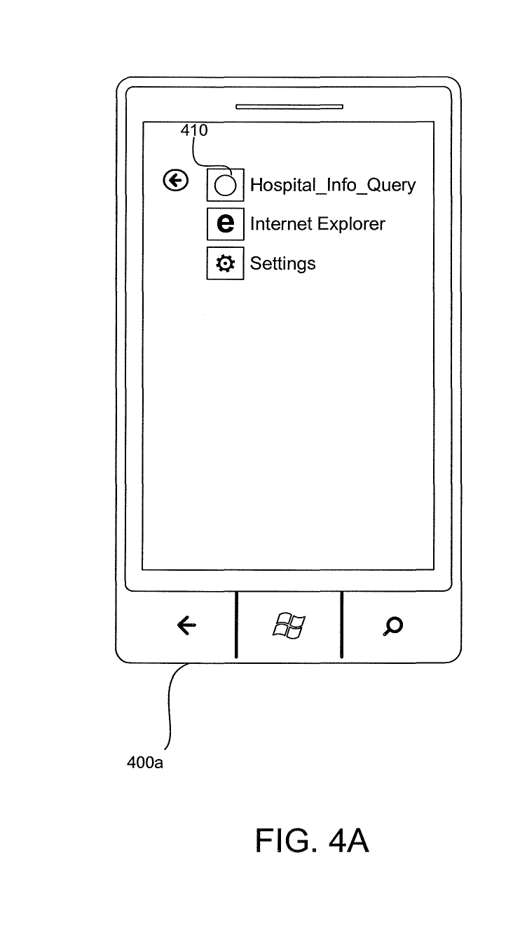

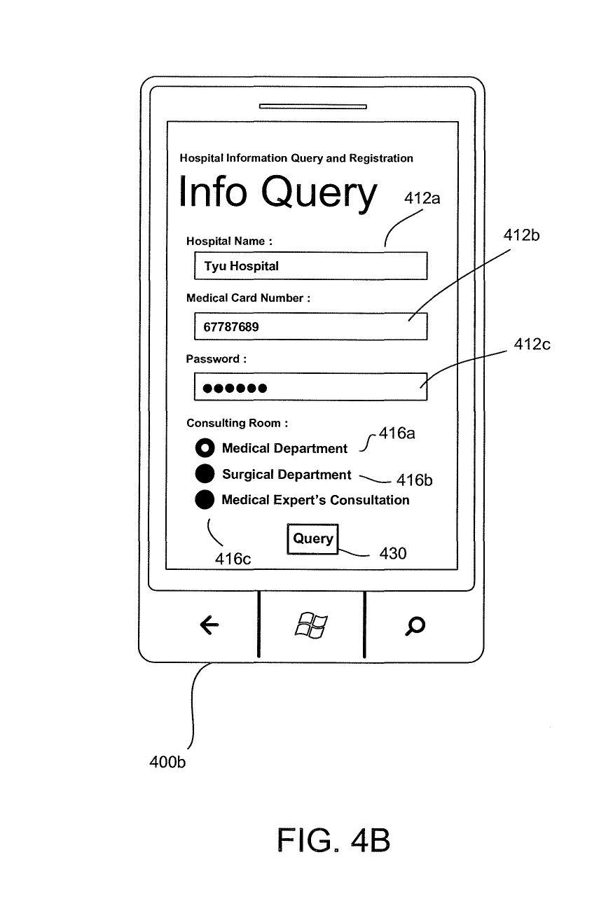

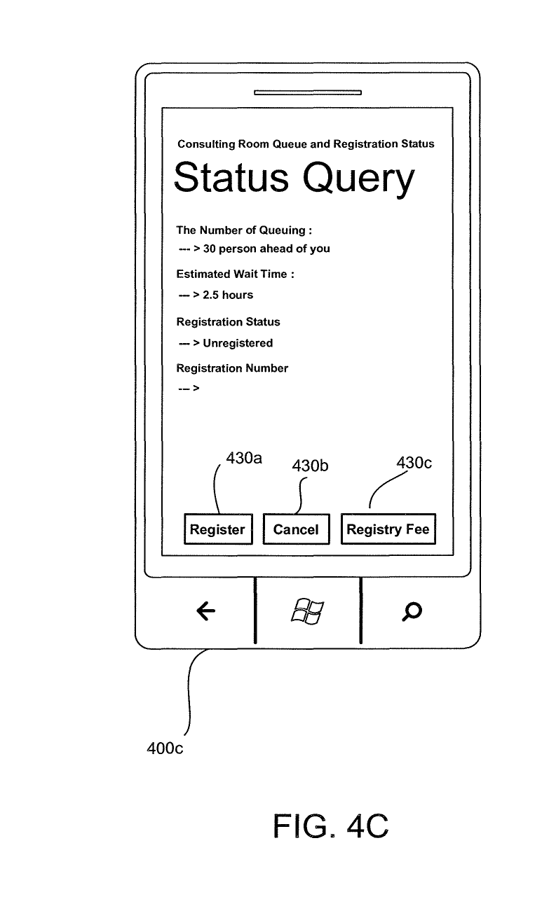

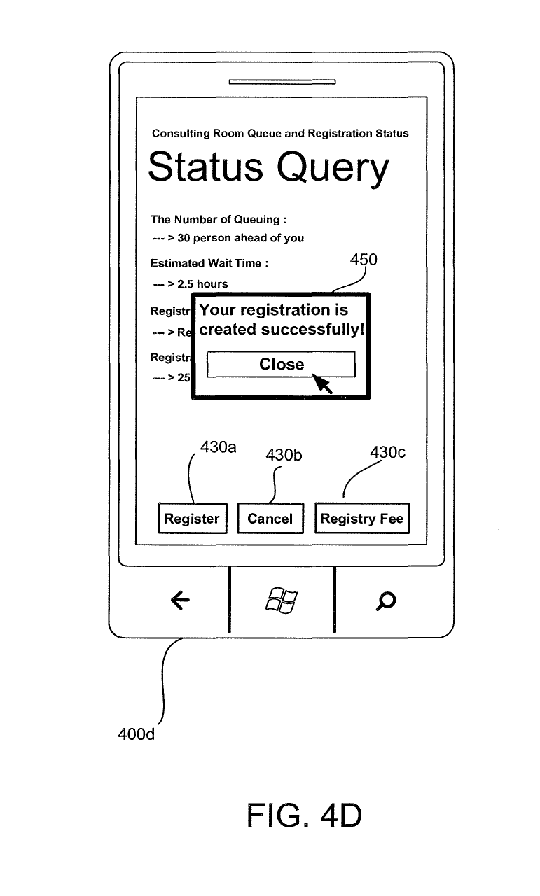

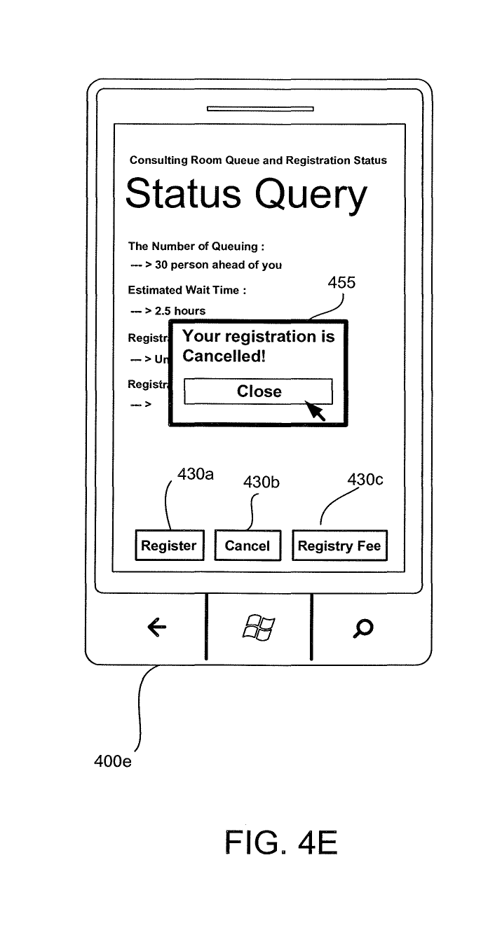

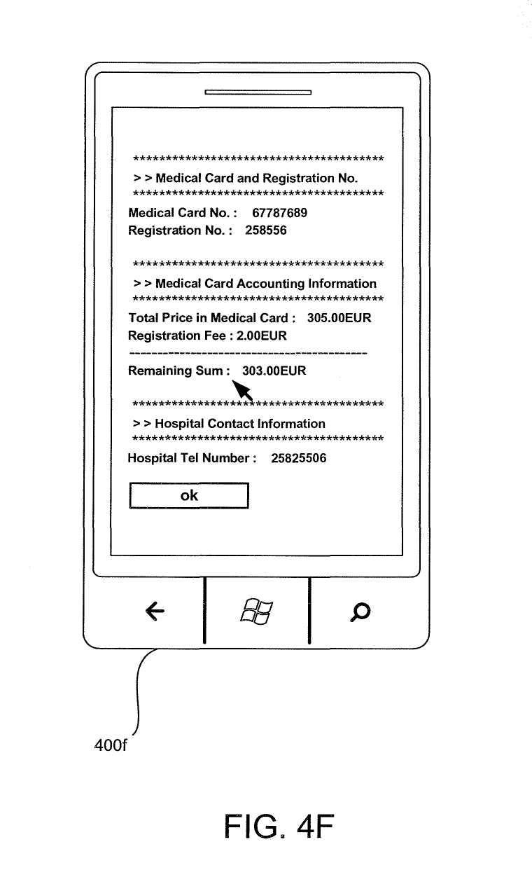

As described, the remote access process is provided as APP, such as a mobile or remote APP. The APP may provide different display or screen pages requesting input through input boxes or with information along with command buttons as to how to proceed. FIGS. 4A-F show various screen pages of the remote access APP for hospital query and registration. Providing an APP for registering with other types of service providers may also be useful. In one embodiment, the screen pages are developed on a mobile development platform, such as WIN7 from Microsoft or IOS from Apple. Providing the screen pages from other platforms may also be useful.

Referring to FIG. 4A, a screen page 400a with icons for various APPs are shown. For example, an icon 410 for an APP to remotely register and query a CRM system is provided. The APP may be referred to as a remote registration or CRM APP. The remote CRM APP facilitates remotely registering and querying a CRM system. In one embodiment, the remote CRM APP facilitates remotely registering and querying a hospital CRM system. Providing an icon for accessing other types of CRMs may also be useful. In some embodiments, the icon can access different CRMs, depending on the customer's need or desire. For example, the user may enter the CRM which is to be accessed. In other embodiments, separate icons may be provided for different service providers. For example, different APPs may be set up for different service providers. In some embodiments, an icon may be provided to different service providers which provide the same type of service. For example, an icon may be provided to access hospitals for remote registration.

To initiate the CRM APP, the user may click on the icon. This may correspond to step 305 of FIG. 3. Clicking on the icon causes the CRM APP to display a login screen page, as shown in FIG. 4B. The login page 400b, for example, may be an information query page. The login page may provide input boxes and selections for services. As shown, the input boxes may include an input box 412a of service provider (e.g., CRM owner), an input box 412b for the unique ID of the user and an input box 412c for the password associated with the unique ID. For example, the service provider identifies the hospital of interest, the unique ID may be a medical card number of the user and the password is associated to the medical card number. As for service selection, it may include the type of service to be provided. For example, in the case of a hospital, the user may select from different medical departments of interest. As shown, three selections 416a-c for medical department, surgical department and medical expert consultation are provided. Providing other types of input boxes and service selections may also be useful. Once the information is entered and/or selected, the user submits it to the CRM of interest. For example, the user submits it to the CRM of interest by pressing the query command button 430. Providing other command buttons on the login page may also be useful. The process of entering information to the remote CRM APP may correspond to step 310 of FIG. 3.

In some cases, in the case where the icon can access different service providers, the CRM APP may recommend from one or more service providers from which the user may select. The recommended service provider may be based on the proximity to the user for convenience. The user may select one of the recommended providers. In the case where the user wishes to select a specific service provider not recommended, the user may enter the name of the service provider.

After submission of the login information, the CRM system of interest returns information related to the user. For example, as shown in FIG. 4C, the CRM APP displays status query page 400c with information of the user. This may include number of customers or patient currently waiting or ahead of the user, estimated waiting time, registration status and registration number. The status query page includes, for example, register, cancel and registry fee command buttons 430a-c. Providing other command buttons may also be useful. For example, a refresh button may be provided. This status query page may correspond to step 330 of FIG. 3.

FIG. 4D shows the status query page 400d when a user selects to register with the CRM system of interest. For example, the user may click or tap on the register command button 430a. This action causes the CRM system of interest to register the user for the service requested. Once registration is completed, the CRM system provides a notification of successful registration 450 to the user through the CRM APP. Additionally, registration number and update status information may also be provided through the status query page. This may correspond to steps 340, 345, 355 and 360 of FIG. 3.

On the other hand, the user may decide not to register for service. For example, the user may cancel the registration or query process by clicking or tapping on the cancel button 430b. This may correspond to steps 340 and 350 of FIG. 3. Alternatively, the user may cancel an existing registration for service. This may correspond to steps 335 and 350 of FIG. 3. Cancelling terminates the process. The CRM system provides a notification of cancellation of registration 455 on the status query page, as shown in FIG. 4E.

The service provider may charge a fee for remote registration process. The fee may be charged to a prepaid account associated with the user. For example, the fee may be charged to the medical card of the user. In one embodiment, clicking on the register command button authorizes the CRM system to charge the prepaid account. The system may pop up a message indicating that a charge has been made to the account. The user may click on the registry fee command button 430c of the status query page. This causes the CRM system to display account information of the customer. For example, the account information may be displayed in an account page 400f, as shown in FIG. 4F.

By providing a remote registration CRM APP, a user may be able to register remotely for service. Successful registering results in a queue number, number of customers ahead in the queue and estimated wait time. This avoids the need for the customer to have long wait time due to a large number of customers being ahead in the queue. This can significantly improve customer experience related to the service. Furthermore, this can result in an increase in customers, thus increasing revenues. Additionally, remote registration is automated. This can reduce the personnel needed for registration process, thus reducing cost. Additionally, due to less number of customers physically waiting in the waiting room, smaller waiting room is required, further reducing costs.

The remote CRM APP is integrated with the CRM system. Integration includes creating one or more function modules which enables the CRM APP to interact and interface with the CRM system. Additionally, integration includes configuring the CRM APP and CRM system for web service. For example, web service enables the CRM APP to access the CRM system remotely, for example, through the internet or mobile network.

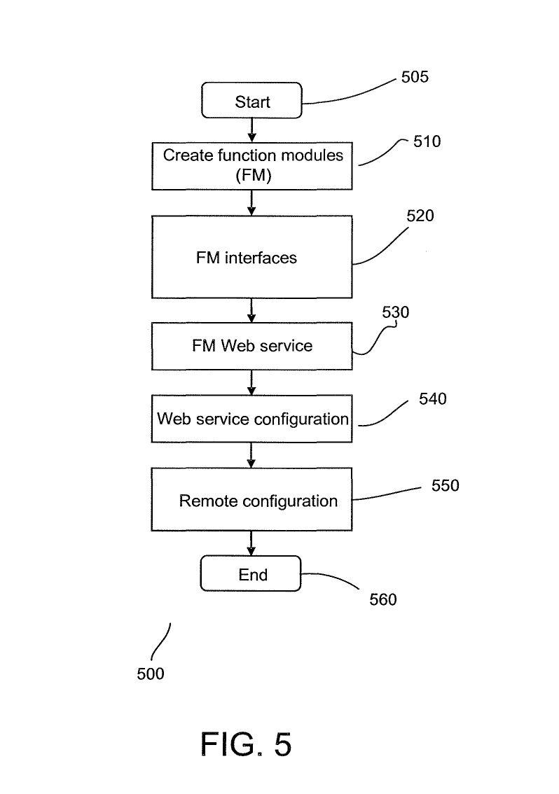

FIG. 5 shows an embodiment of a CRM APP integration process 500. In one embodiment the integration process is performed for a mobile CRM APP. The integration process, as illustrated, integrates a mobile CRM APP with a SAP CRM system. Integrating the CRM APP to other types of CRM systems may also be useful. The integration process commences at step 505. The integration process includes creating different function modules in the backend CRM system to enable access by a mobile device to the CRM system.

For example, at step 510, function modules are created in the backend CRM system. In one embodiment, function modules include various types of activity modules. For example, a mobile registration is considered an activity in the CRM system. The function modules, in one embodiment, include a create activity function module, a change activity module and a search activity function module. These various function modules are used to implement functions based on application operation or service request from the mobile device. For example, the create function module is used to create a new activity for a new registration, change function module is used to update information or cancel a registration while the search function module is used to check whether a registration already exist. Providing other types of function modules may also be useful. Also, related fields on the remote user interface representing business meanings are defined in the database tables in the backend system.

The function modules may be created using Advanced Business Application Programming (ABAP) programming language from SAP. Creating the function modules using other types of programming language may also be useful. The process of creating the function modules, for example, may depend on the type of CRM system.

At step 520, function modules used as interfaces for communication between the mobile device and the CRM system are created. In one embodiment, interface function modules include create activity, get activity detail and get activity list function modules. These communication interface modules are used to set default or define values between mobile UI and the database table to enable the activity functions to be invoked. For example, create activity interface function module is used to invoke the create activity function module while the get activity detail and list function modules are used to invoke the search function module. The get activity detail returns information of a single activity while the list function returns a list of activities. For example, a patient may have multiple registrations to different departments. In such cases, the patient may query the status of those registrations.

The process continues to step 530. At step 530, web service is created. The web service, for example, is based on a function module or a function group. This enables connection between the module device and the CRM system. The web service may be created with the help of a wizard. At step 540, the web service function module is configured. Configuration, for example, may be performed through a service oriented architecture (SOA) manager, such as SOAMANAGER. Configuration may include generating service definition based on the function modules to get information such as properties, WSDL, XML, URL as well as others. For example, the basic Web services platform is XML+HTTP. XML provides a language which can be used between different platforms and programming languages while still capable of complex messages and functions while HTTP is the most widely used internet protocol. Web services platform elements include simple object access protocol (SOAP), universal description, discovery and integration (UDDI) and web services description language (WSDL). As for the URL, it is in the form of http://xxx as a link or interface used to connect the mobile device or network to the CRM system. The configuration selects binding and other setting modifications for web service.

At step 550, the process continues to perform configuration on a mobile development platform. The mobile development platform, for example, may be WIN7 or IOS. Other types of mobile development platforms may also be useful. In one embodiment, objects representing request to load URL content is created. Additional objects to check whether data connection between the mobile device and CRM system is successful or not are created.

As described, the integration process involves integrating a CRM APP to a SAP CRM system. However, it is understood that the process can be adopted to integrate the CRM APP to other types of CRM systems. For example, the integration process may be adopted for different class definitions based on the mobile development platform as well as CRM system.

Although the one or more above-described implementations have been described in language specific to structural features and/or methodological steps, it is to be understood that other implementations may be practiced without the specific features or steps described. Rather, the specific features and steps are disclosed as preferred forms of one or more implementations.

1. A computer-implemented method for remote registration for customer service comprising:
providing a customer relationship management (CRM) system of a medical service provider;
providing a remote registration application (APP) at a remote client device for remote registration for service with the CRM system, the method includes configuring the APP to communicate with the CRM system;
invoking the remote registration APP by a user using the remote client device; and
providing log in information to the APP, wherein the APP communicates with the CRM system to register the user for service, upon successful registration, the APP provides the user registration information, wherein the registration information comprises
a registration number,
a number of other customers ahead of the user, and
an estimated wait time.

2. The computer-implemented method of claim 1 wherein configuring the APP comprises creating:
a create activity module, wherein the create activity module is used to create a new remote registration;
a change activity module, wherein the change activity module is used to update an existing registration; and
a search module, wherein the search module is used to search whether the new registration already exists in the CRM system.

3. The computer-implemented method of claim 1 wherein the remote registration comprises:
providing a unique user identification number associated to the user;
determining if the user is already registered for service;
if the user is already registered for service, the user can select to cancel or to maintain the registration;
if the user is not already registered, the user can select to register for service to continue the registration process or to cancel to end the registration process; and
displaying registration information if the user selects to register.

4. The computer-implemented method of claim 1 wherein the remote client device is a mobile client device.

5. The computer-implemented method of claim 1 wherein the CRM system includes a backend subsystem located on a server.

6. A computer-implemented method for remote registration for customer service comprising:
providing a customer relationship management (CRM) system of a service provider;
providing a remote registration application (APP) at a remote client device for remote registration for service with the CRM system, the method includes configuring the APP to communicate with the CRM system;
invoking the remote registration APP by a user using the remote client device; and
providing log in information to the APP, wherein the APP communicates with the CRM system to register the user for service.

7. The computer-implemented method of claim 6 wherein the remote registration comprises:
performing a login process by the user to the CRM system by providing a unique user identifier associated with the user to login to the CRM system;
determining if the user is already registered for service;
if the user is already registered for service, the user can select to cancel or to maintain the registration;
if the user is not already registered, the user can select to register for service to continue the registration process or to cancel to end the registration process; and
displaying registration information if the user selects to register.

8. The computer-implemented method of claim 7 wherein the login further comprises:
selecting a service provider;
selecting the type of service requested; and
providing a password associated to the unique user identifier.

9. The computer-implemented method of claim 8 wherein the user is provided with a list of service providers based on a location of the user.

10. The computer-implemented method of claim 7 wherein the registration information comprises:
a registration number;
a number of other customers ahead of the user; and
an estimated wait time.

11. The computer-implemented method of claim 6 wherein configuring the APP comprises:
creating one or more function modules to perform functions of remote registration with the CRM system;
creating interface modules;
creating web service; and
configuring the web service to enable communication of the CRM system by the remote client device.

12. The computer-implemented method of claim 11 wherein the function modules comprise activity modules related to registration activities.

13. The computer-implemented method of claim 12 wherein the activity modules comprise:
a create activity module, wherein the create activity module is used to create a new remote registration;
a change activity module, wherein the change activity module is used to update an existing registration; and
a search module, wherein the search module is used to search whether the new registration already exists in the CRM system.

14. The computer-implemented method of claim 11 wherein the interface modules comprise:
a create activity interface module;
a get activity detail interface module; and
a get activity list interface module.

15. The computer-implemented method of claim 6 wherein the service provider comprises a hospital.

16. The computer-implemented method of claim 6 wherein the remote client device is a mobile client device.

17. The computer-implemented method of claim 6 wherein the CRM system includes a backend subsystem located on a server.

18. A non-transitory computer-readable medium having stored thereon program code, the program code executable by a computer to:
provide a customer relationship management (CRM) system of a service provider;
provide a remote registration application (APP) at a remote client device for remote registration for service with the CRM system, the method includes configuring the APP to communicate with the CRM system;
invoke the remote registration APP by a user using the remote client device; and
provide log in information to the APP, wherein the APP communicates with the CRM system to register the user for service.

19. A system comprising:
a non-transitory memory device for storing computer-readable program code; and
a processor in communication with the memory device, the processor being operative with the computer-readable program code to:
provide a customer relationship management (CRM) system of a service provider;
provide a remote registration application (APP) at a remote client device for remote registration for service with the CRM system, the method includes configuring the APP to communicate with the CRM system;
invoke the remote registration APP by a user using the remote client device; and
provide log in information to the APP, wherein the APP communicates with the CRM system to register the user for service.

20. The system of claim 19 wherein the registration information comprises:
a registration number;
a number of other customers ahead of the user; and
an estimated wait time.
